(19) United States
(12) Patent Application Publication
(10) Pub. No.: US 2018/0004246 A1
(43) Pub. Date: Jan. 4, 2018

(54) Computer System

(71) Applicant: Hitachi, Ltd., Chiyoda-ku, Tokyo (JP)

(72) Inventors: Taku SHIMOSAWA, Tokyo (JP); Hidehiro KAWAI, Tokyo (JP); Hiroshi MINE, Tokyo (JP); Satoshi OOSHIMA, Tokyo (JP)

(21) Appl. No.: 15/538,039

(22) PCT Filed: Jan. 23, 2015
(86) PCT No.: PCT/JP2015/051753

§ 371 Date: Jun. 20, 2017

(51) Int. Cl. G06F 1/14; G06F 13/24

(52) U.S. Cl. CPC G06F 1/14; G06F 13/24

(57) ABSTRACT

A problem to be solved by the present invention is, in a computer system, to reduce processing delay from wait times which occur in timer access. According to the present invention, using either a CPU core (hereinafter “processing core”) other than a CPU core which executes an application, or a DMA device, a latest timer value is always transferred from a timer device to a primary storage device. The processing core reads the transferred value upon the primary storage device instead of accessing a register of the timer device, thereby avoiding a wait which occurs when directly reading the timer value of the timer device. The transfer of the value is carried out asynchronously from the processing of the processing core, thus obviating the need for the processing core to wait for the completion of the transfer. Accordingly, it is also unnecessary for the processing core to process an interrupt or a notification from another CPU core or the DMA device.

### TECHNICAL FIELD

The present invention relates to a computer system, and specifically to a technology of handling a timer device.

### BACKGROUND ART

Patent Literature 1 discloses that a DMA engine is instructed to transmit data stored in a plurality of memory areas, the DMA engine transmits the specified data sequentially, and the DMA engine receives the transmit instruction again after completing the transmit, thereby repeating the same processing.

### CITATION LIST

### Patent Literature

Patent Literature 1: U.S. Pat. No. 6,111,592 A

### SUMMARY OF INVENTION

### Technical Problem

In general, when a central processing unit (CPU) performs reading and/or writing on various storage devices, a difference between an operation clock of the CPU and an operation clock of the storage device or a property of the storage device causes a “wait” of the CPU. The “wait” is more prominent, compared to the case of the primary storage device, in reading from and writing to a register of an input/output device accessed in a way similar to the primary storage device being read/written by the CPU.

As a means for reducing the “wait”, there is a method of transferring a content using a DMA device out of synchronization with the CPU, as described in Patent Literature 1. Patent Literature 1 describes the method of repeating the transfer of the content by the DMA device, which is intended to transmit the data between the primary storage devices but not for an access to the input/output device. The input/output device may not necessarily be accessible by the DMA device, but its value may need some kind of conversion when being used by software. In addition, since an interrupt occurs to the CPU upon completion of the transmission by the DMA device, there is a problem that frequent transmissions may increase the processing load on the CPU due to an interrupt handler.

The present invention aims to address the issue of the “wait” caused by an access to the register of the input/output device while minimizing the increase of the processing load due to the interrupt.

### Solution to Problem

In the present invention, a CPU core or a DMA device other than the CPU core performing a processing that needs to access the register (hereinafter, referred to as a processing core or a processing unit) is used to constantly transfer the latest value from the device register to the primary storage device. The processing core is not limited to performing the processing of the interrupt handler but it can also avoid the wait that occurs when directly reading the device register by reading the transferred value on the primary storage device instead of accessing the register. Since the value transfer is performed out of synchronization with the processing core, the processing core has neither to wait for completion of the transfer nor to process the interrupt or notification from another CPU core or the DMA device.

### Advantageous Effects of Invention

According to one aspect of the present invention, it is possible to reduce delay of the register of the input/output device caused by a read access when there are too many read accesses, and thereby improving a use efficiency of the processing core.

### BRIEF DESCRIPTION OF DRAWINGS

FIG. 1 is a diagram showing an exemplary configuration of a computer system according to Example 1.

FIG. 2 is a diagram showing an exemplary flow of timestamp information in the configuration of the computer system.

FIG. 3 is a diagram showing an exemplary operation flow of recording a trace log in the computer system.

FIG. 4 is a diagram showing an exemplary operation flow of transferring a timestamp in the computer system.

FIG. 5 is a diagram showing an exemplary effective operation order by having a timestamp counter.

FIG. 6 is a diagram showing an exemplary configuration of a computer system according to Example 2.

FIG. 7 is a diagram showing an exemplary internal structure of a task management table in the configuration of the computer system.

FIG. 8 is a diagram showing an exemplary data flow of timestamp and interrupt setting information in the configuration of the computer system.

FIG. 9 is a diagram showing an exemplary operation flow performed by the computer system at the beginning of a task when monitoring operating time of the task.

FIG. 10 is a diagram showing an exemplary operation flow performed by the computer system at the end of the task when monitoring operating time of the task.

FIG. 11 is a diagram showing an exemplary operation flow performed by the computer system at an occurrence of timer interrupt when monitoring operating time of the task.

FIG. 12 is a diagram showing an exemplary operation flow of transferring the timestamp information and the interrupt setting information when monitoring operating time of the task.

### DESCRIPTION OF EMBODIMENTS

### Example 1

This example achieves, as described below, a trace log function of recording a log of an operation of an operating system on a computer system. The trace log needs to record a timestamp at which an event to be recorded occurred along with the event for use in a later analysis.

The present invention is beneficial to obtain timestamp information so as not to influence the process of the CPU that records the event.

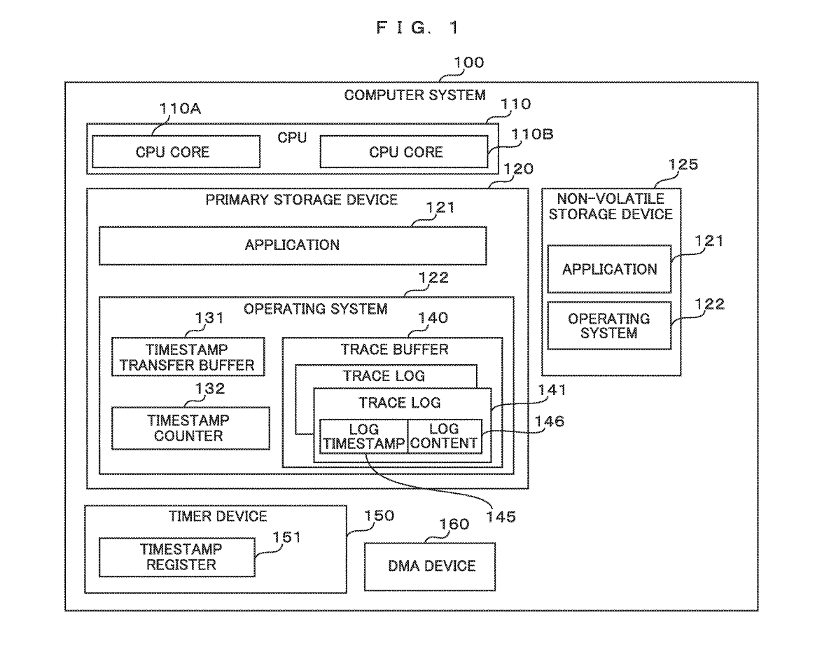

FIG. 1 is a diagram showing an exemplary configuration of a computer system 100. The computer system 100 includes at least one CPU 110 and a primary storage device 120, a non-volatile storage device 125, a timer device 150, and a DMA device 160.

The CPU 110 may be a general-purpose processor, which reads out software such as an application 121 and an operating system 122 from the non-volatile storage device 125 or the like, and deploys and executes the software on the primary storage device 120 as needed. Although FIG. 1 shows a single CPU 110 and the CPU 110 is constituted by two cores (processing units), the number of the CPU may be two or more and the number of the CPU cores may be one or more than two. When there are two or more CPU cores, they may be present on the same CPU 110 or on different CPUs 110, or a combination thereof is also acceptable. Furthermore, the CPU cores may have different architectures or different throughput. The CPU 110 may be a processor such as, for example, RH 850. This example is described assuming the CPU core that requires the timestamp information as a CPU core 110A and the CPU core that transfers the timestamp information from a device as a CPU core 110B.

The primary storage device 120 is a readable/writable non-volatile storage area, on which command is executed by the CPU 110, or which is readable and writable by a command including a load command and a store command. Arranged on the primary storage device 120 are software program and data including the application 121 and the operating system 122. As described later, however, there may be arranged the program and data that are not rewritten upon execution on the non-volatile storage device 125, and in such a case, the program and data on the non-volatile storage device 125 may not be present on the primary storage device 120. The primary storage device 120 is constituted by, for example, a DRAM or the like.

The non-volatile storage device 125 is a readable non-volatile storage area, on which a command is executed by the CPU 110, or which is readable by a load command. By arranging the program and data that does not cause rewrite of the software, it is also possible for the CPU 110 to directly execute or read them. Hereinafter, the explanation is given assuming that all the software program and data are present on the primary storage device 120, and the same applies to a case in which a part of the software program and data is located on the non-volatile storage device 125.

The application 121 is software for achieving a function provided by the computer system 100. The application 121 consists of a single or a plurality of tasks. The computer system 100 may include only one application 121 or a plurality of applications 121. The operating system 122 is capable of multi-task processing, which can execute a plurality of applications 121 and tasks thereof in parallel. The operating system 122 switches operations between tasks, copes with an interrupt from an input/output device, and the like. The computer system 100 may also take an OS-less configuration used for an embedded device, in which case there is no distinction between the application 121 and the operating system 122 and a single task provides the functions of the application 121 and the operating system 122. Hereinafter, the explanation is given assuming that the application 121 is distinguished from the operating system 122, and the same applies to the case of the OS-less configuration.

The operating system 122 includes a timestamp transfer buffer 131, a timestamp counter 132, and a trace buffer 140 as its data structure, for example. Naturally, the operating system 122 may also include other data structures to provide functions required for the operating system. The timestamp transfer buffer 131 is an area that stores therein a value indicative of information of a timestamp transferred from a register of a device that stores therein the information. The timestamp counter 132 is incremented by 1 every time the timestamp transfer buffer 131 is read out. The trace buffer 140 is an area to record a certain event that occurred in the operating system 122 and to store a trace log 141 no smaller than 0. Each trace log 141 corresponds to an occurrence of a single or a plurality of events. The event to be recorded may be for example, an interrupt that occurred or switching of tasks executed in the operating system 122, and the event to be recorded may be altered depending on its application or may be dynamically altered depending on the state of execution.

The trace log 141 includes a log timestamp 145 and a log content 146 as an internal structure. The log timestamp 145 indicates a timestamp at which an event corresponding to the trace log 141 occurred. The log content 146 indicates the content of the event. The log content 146 may include, for example, a type of the event, information about an object of the event such as a number indicative of the type of the interrupt in the case of the interrupt, and the like.

The timer device 150 is a device that measures actual time. For example, it may be a device that includes a counter which counts up based on a clock at a constant period and it may not necessarily indicate an absolute timestamp. The counter of the timer device 150 can gain the value by accessing the timestamp register 151 from the CPU 110. A method of accessing the timestamp register 151 by the CPU 110 may use a dedicated I/O port command or a load command to a specific address. It should be noted that, however, the “wait” time caused to the reading of the value is longer than that caused to the reading of a value by the primary storage device 120.

The DMA device 160 is a device that performs memory transmission independently of the CPU 110. The DMA device 160 transfers a specified size of the content from a specified source address to a specified destination address according to an instruction from the CPU 110. In this example, when performing the transfer by the CPU core 110B, the DMA device 160 is not always required; on the other hand, the DMA device 160 can also be used for the transfer from the register as an alternative for the CPU core 110B. The processing in the case of using the DMA device 160 as an alternative will be described at the end of description of this example.

Although FIG. 1 shows the CPU 110, the primary storage device 120, the operating system 122, and the timer device 150 as discrete components on the computer system 100, they may be incorporated on a single chip in a form of so-called SoC (System-on-a-chip). In such a case, they can be logically treated in a similar manner, and therefore the following description can be applied thereto.

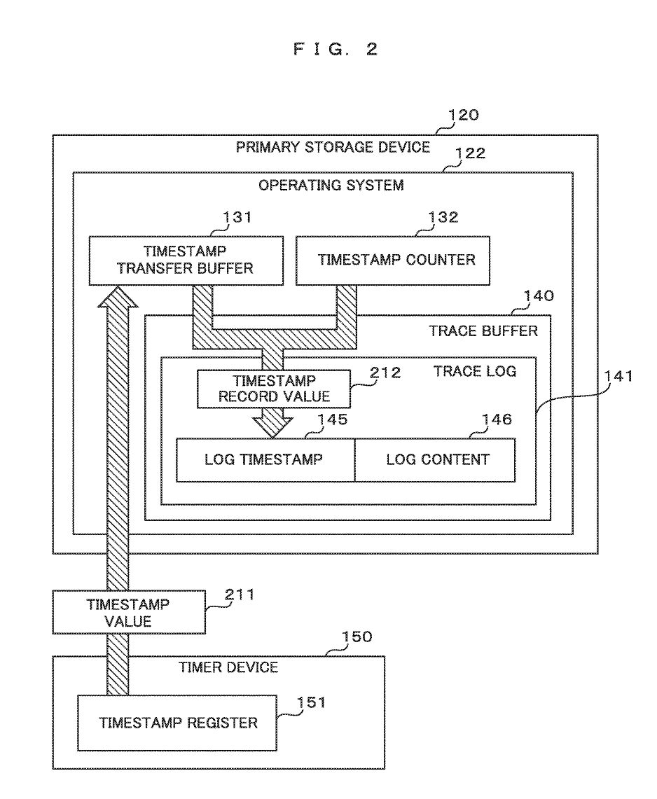

FIG. 2 is a diagram showing an exemplary flow of data related to a timestamp.

In this example, the CPU core 110B in charge of transfer reads out a value from the timestamp register 151, which is used as a timestamp value 211. The timestamp value 211 may be the same value as the read value or may be another value appropriately converted therefrom. The timestamp value 211 is written to the timestamp transfer buffer 131 asynchronously at a timing different from the processing by the CPU core 110A. This enables the transfer from the timestamp register 151 to the timestamp transfer buffer 131. The CPU core 110A requiring the timestamp information calculates a timestamp record value 212 from values of the timestamp transfer buffer 131 and the timestamp counter 132. This may be a value simply connecting the timestamp transfer buffer 131 and the timestamp counter 132 or a value appropriately converted therefrom. One example of the timestamp information would be the log timestamp 145 of the trace log 141, and the CPU core 110A stores the timestamp record value 212 in the log timestamp 145.

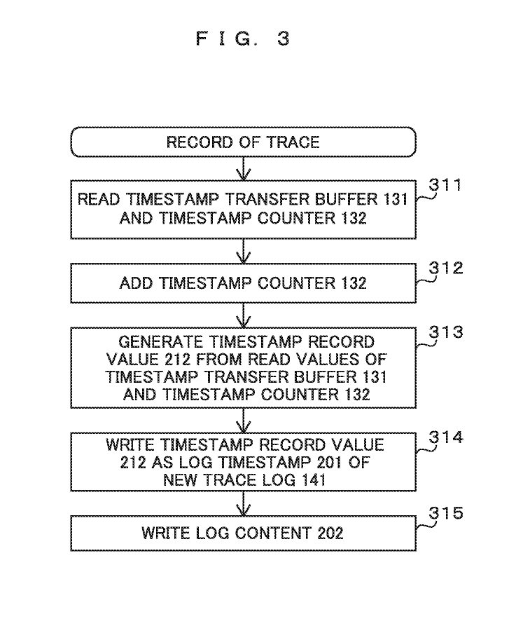

FIG. 3 is a diagram showing an exemplary operation flow of the CPU core 110A that records an occurrence of a new event as the trace log 141, as an example of obtaining timestamp information. First, values are read out of the timestamp transfer buffer 131 and the timestamp counter 132, respectively (311). By adding 1 to the value read from the timestamp counter 132 and writing it back to the timestamp counter 132, the timestamp counter 132 is incremented by 1 (312). Next, the timestamp record value 212 to be used as the timestamp information is generated from the read values of the timestamp transfer buffer 131 and the timestamp counter 132 (313). To do so, for example, there is a way to associate the values. In this case, the size of the timestamp record value 212 is the total size of the timestamp transfer buffer 131 and the timestamp counter 132. Otherwise, it is also possible to shift the timestamp transfer buffer 131 to the left and combine lower bits of the timestamp counter 132 by the number of bits shifted to the left. Next, the timestamp record value 212 is written to the log timestamp 145 of the new trace log 141 (314). The content of the event is then written to the log content 146 (315). Next, the trace log 141 performs addition to the trace buffer 140, if needed. The above-described processing can take the log of the event in the operating system 122, and the timestamp at which the event occurred can be recorded in the log.

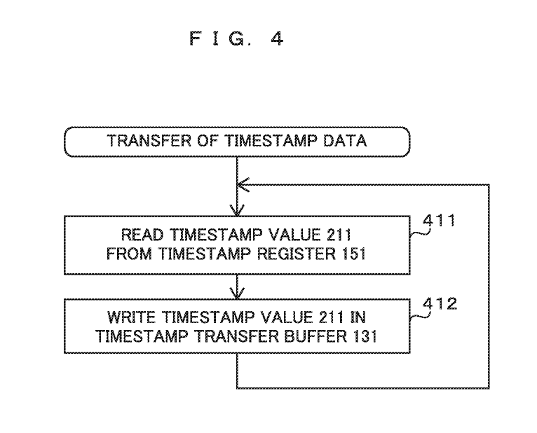

Description is now given with reference to FIG. 4. This is an exemplary operation flow in which the CPU core 110B transfers the timestamp information from the timestamp register 151. The CPU core 110B reads out the value from the timestamp register 151 and obtains the timestamp value 211 (Step 411). At this time, a conversion such as taking out a part of bits from the value of the timestamp register 151 may be performed, if necessary. Next, the obtained timestamp value 211 is written to the timestamp transfer buffer 131 (412). Then the process returns to Step 411, and the steps are repeated. Thus, the transfer from timestamp register 151 to the timestamp transfer buffer 131 is performed continuously, and accordingly the CPU core 110A that reads out the timestamp transfer buffer 131 can obtain a value close enough to, but not equal to, the latest timestamp register 151 at the point of reading without accessing the timestamp register 151.

In other words, because the “wait” caused by reading from the primary storage device 120 is sufficiently shorter than the “wait” caused by the direct reading from the timestamp register 151, it is possible to reduce the delay caused when the CPU core 110A directly accesses the timestamp register 151.

It should be noted that other processing than in the operation flow of transfer described above may be performed as the processing of the CPU core 110B. In such a case, it is also possible to put the lowest priority to the operation flow of transfer so that, if there is any other task to be executed, it is executed.

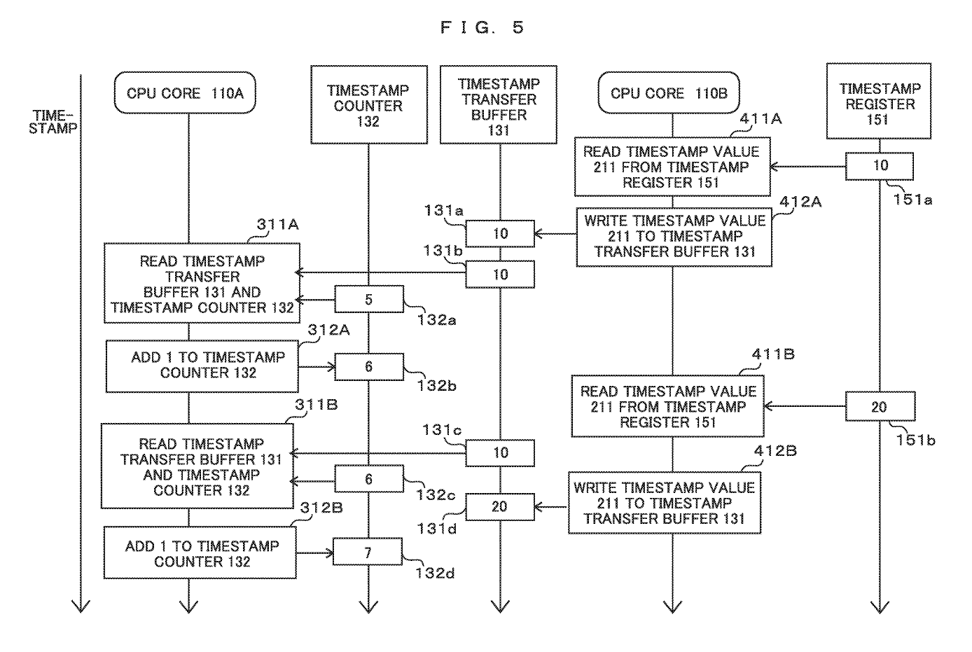

FIG. 5 is a diagram illustrating an effect by using two values of the timestamp transfer buffer 131 and the timestamp counter 132 in generating the timestamp record value 212, indicating an example of the operation order when the CPU core 110A and the CPU core 110B operate and the transition of the values of the timestamp register 151, the timestamp transfer buffer 131, and the timestamp counter 132, respectively, according to the operation flow described with reference to FIGS. 3 and 4. It should be noted that, for the operation flow of the CPU core 110A and the CPU core 110B, the case of repeating the processing shown in FIG. 3 and FIG. 4 two times respectively is shown extracting only steps related to the description. Initial values of the timestamp register 151 and the timestamp counter 132 are 10 and 5, respectively (Steps 151a, 132a), and for the value of the timestamp transfer buffer 131, the value read from the timestamp register 151 is used as it is.

In FIG. 5, the lapse of time is indicated from the top to the bottom, and the description thereof is given starting from the top. First, the CPU core 110B reads a value from the timestamp register 151 (Step 411A). At this time, the value of the timestamp register 151 is 10 (Step 151a), and the timestamp value 211 is 10.

Next, the CPU core 110B writes the timestamp value 211 to the timestamp transfer buffer 131 (Step 412A). This changes the value of the timestamp transfer buffer 131 to 10 (Step 131a). The CPU core 110A starts processing thereafter to read values from the timestamp transfer buffer 131 and the timestamp counter 132 (Step 311A). These values are 10 and 5, respectively (Steps 131b, 132a). By adding 1 to the timestamp counter 132 (Step 312A), the value of the timestamp counter 132 becomes 6 (Step 132b). As a result, the timestamp record value 212 obtained by the CPU core 110A in the form of (timestamp transfer buffer 131, timestamp counter 132) is (10, 5).

Now, consider that the CPU core 110B performs the transfer processing again. The processing includes, as in the case described previously, read-out from the timestamp register 151 (Step 411B) and write to the timestamp transfer buffer 131 (Step 412B). The value of the timestamp register 151 at this time is assumed to be 20 (Step 151b).

Now, consider the case in which the recording of the next log by the CPU core 110A is performed in parallel and the read-out from the timestamp transfer buffer 131 and the timestamp counter 132 (Step 311B) is performed earlier than

Step 411B. In this case, the values read by the CPU core 110A are 10 and 6 (Steps 131c, 132c), and the timestamp record value 212 obtained by the CPU core 110A is (10, 6). The write by the CPU core 110B (Step 412B) then changes the timestamp transfer buffer 131 to 20 (Step 131d), then the timestamp counter 132 indicates 7 (Step 132d) by addition by the CPU 110A (Step 312B).

By the processing described above, the CPU core 110A obtains the values of (10, 5) and (10, 6) from the two calculations of the timestamp record value 212. If there is no timestamp counter 132, only the timestamp transfer buffer 131 can be used to calculate the timestamp record value 212, which makes the two timestamp record values 212 both 10. As a result, the first and second timestamp record values 212 cannot be distinguished from each other, which makes it difficult to determine the order of the two trace logs 141 by their log timestamps 145 although there is actually the order. According to this example, however, the different values of (10, 5) and (10, 6) can be obtained, and their order can be apparently determined by the values of the timestamp counters 132.

In other words, since the processing of the CPU 110A is not linked to the processing of the CPU 110B, it is possible to avoid that the CPU 110A receives the same timestamp despite the lapse of time.

It should be noted that, depending on the usage of the obtained trace log 141, when there is no need of distinguishing between the two timestamp record values 212 described with reference to FIG. 5, naturally the timestamp counter 132 may not be used but only the value of the timestamp transfer buffer 131 can be used.

In contrast, it is also conceivable to use only the timestamp counter 132 and use it as the timestamp value 211. In this case, however, since the value of the timestamp register 151 indicative of the actual time is not reflected at all, the accuracy is low as the timestamp information and only the order can be obtained. Using the timestamp transfer buffer 131 makes it possible to obtain information of the actual time, though not a real-time value.

When the DMA device 160 can access the timestamp register 151 in the same manner as loading the primary storage device 120 and the value of the timestamp transfer buffer 131 is stored in the same manner as the timestamp register 151, it is also possible to use the DMA device 160 instead of the CPU core 110B. In this case, a given core of the CPU 110 can perform the transfer by the DMA device 160 setting the timestamp register 151 as the source address, the timestamp transfer buffer 131 as the destination address, and the size of the timestamp register 151 as the transmission size. Furthermore, if the DMA device 160 can notify the CPU 110 of completion of the transfer in the form of interrupt, the CPU 110 is by the notification the DMA device 160 to perform the transfer again. Moreover, if the DMA device 160 can be set to repeat the transfer, the CPU 110 may set the transfer only once when initializing the operating system 122. In this case, the DMA device 160 does not need to interrupt the CPU 110 due to completion of the transfer and thus the CPU 110 does not need to process the interrupt. In this manner, the DMA device 160 can replace the transfer function performed by the CPU core 110B in the above description.

### Example 2

Example 2 is related to a function of monitoring whether execution time of each task exceeds a prespecified timestamp on an operating system, specifically on a real-time operating system

In order to monitor whether the prespecified timestamp is exceeded, it is necessary to notify the timer device of the timestamp used as a reference for determination and, if the timestamp is exceeded, to notify the CPU by causing only a timer interrupt to the timer device.

However, there is a problem of requiring many operation clocks to set an interrupt timestamp to the timer device as in Example 1. To address this problem, delay of an application can be prevented by causing the CPU core that is not executing the application to set the interrupt timestamp to the timer device instead of causing the CPU core that is executing the application to set the interrupt timestamp. The specific processing thereof is described below.

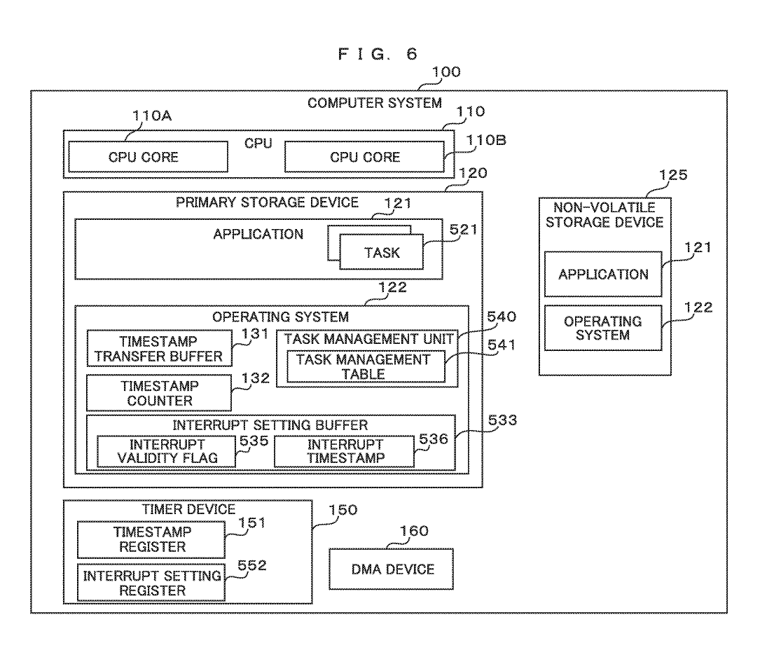

FIG. 6 shows a schematic diagram of Example 2. Description of what are common with Example 1 is not provided again but only different points will be described.

A task 521 constitutes the application 121. Although there is a plurality of tasks 521 in FIG. 6, there may be only one.

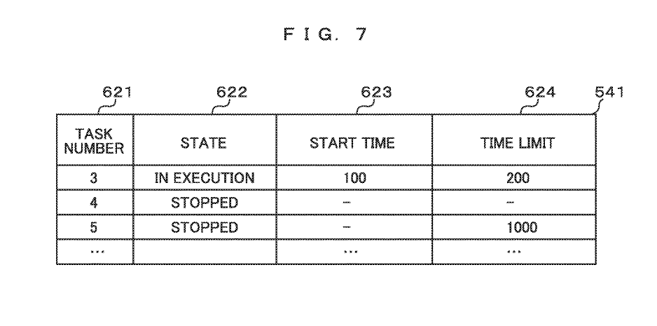

A task management unit 540 manages information of the task 521, and includes, for example, a task management table 541. The task management table 541 is a table that contains information about each task 521 in one row for management of the task 521. Details thereof will be described with reference to FIG. 7.

The timer device 150 includes a function of interrupting the CPU 110 when the value of the timestamp register 151 reaches a set value, in addition to the functions described with reference to Example 1. The timer device 150 includes an interrupt setting register 552, which sets whether to validate occurrence of an interrupt, a value of the timestamp register 151 that causes the interrupt, and the like.

The operating system 122 includes an interrupt setting buffer 533 and a task management unit 540. The interrupt setting buffer 533 stores therein a value to be set to the interrupt setting register 552 of the timer device 150 to be described later, and the like. The interrupt setting buffer 533 includes, for example, an interrupt validity flag 535 and an interrupt timestamp 536. The interrupt validity flag 535 is a value indicating that, for example, the interrupt validity flag 535 indicates, if it stores therein a value to be “valid”, that the CPU 110 is interrupted when the value in the timestamp register 151 reaches the interrupt timestamp 536 and if it stores therein a value to be “invalid”, it indicates that no interrupt can occur even when the value in the timestamp register 151 reaches the interrupt timestamp 536. However, because it is naturally present on the primary storage device 120, the behavior of the timer device 150 cannot actually be changed unless it is transferred to the interrupt setting register 552 that achieves these functions of the timer device 150.

FIG. 7 is a diagram showing an exemplary internal structure of the task management table 541. The task management table 541 includes, for example, a task number 621, a task state 622, a start time 623, and a time limit 624. The task number 621 is an identifier for identifying each task 521, which is an integer value such as 3. The task state 622 is a column indicative of the state of each task 521, which may be “in execution” and “stopped”, for example. The start time 623 indicates the timestamp at which each task 521 started the execution and, for example, stores therein the timestamp record value 212 at the time of starting. The time limit 624 indicates the maximum time period during which each task 521 can operate. This value can be calculated based on the value of the timestamp record value 212, and it may simply be a difference from the timestamp record value 212, for example.

Although the task is managed based on the time limit in this example, it may be managed based on the timestamp instead of the time limit. For example, although the start time is set to 100 and the time limit is set to 200 in an example of task 3, the interrupt timestamp may be set to 300 instead of the time limit for management.

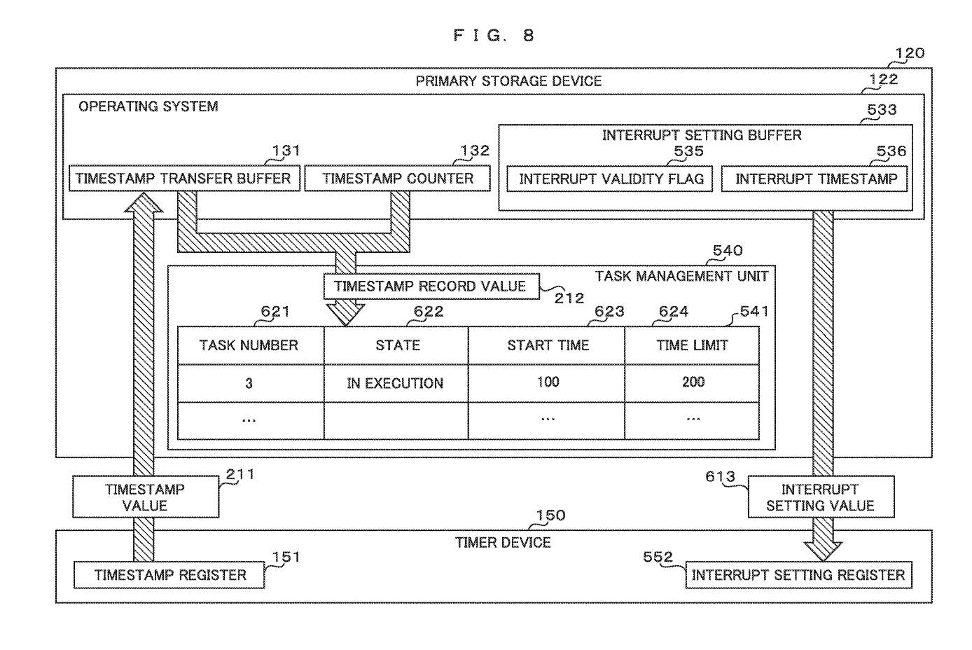

FIG. 8 is a diagram showing an exemplary flow of data about the timestamp and interrupt setting information. Since the data flow of the timestamp information is similar to what was described with reference to FIG. 2, the description thereof is not provided again, but only transfer of the interrupt setting information is described below. The transfer is performed after the value of the interrupt setting buffer 533 on the primary storage device 120 is converted into an interrupt setting value 613 to be set in the interrupt setting register 552. Internal expression of the interrupt setting register 552 depends on the specification of the timer device 150, and therefore a simple transfer will do if the internal expression of the interrupt setting value 613 is the same as that of the interrupt setting register 552.

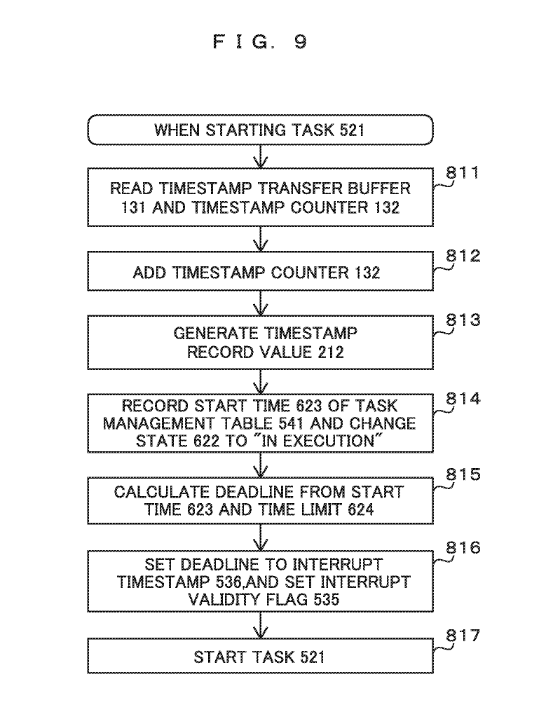

FIGS. 9, 10, and 11 are diagrams showing exemplary processing flows performed by the CPU core 110A in this example when starting the execution of the task 521 in the application, when terminating the execution of the task 521, and when an interrupt by the timer device 150 occurs, respectively.

First, the flow when starting the execution of the task 521 in the application is described with reference to FIG. 9. Description of Steps 811, 812, and 813 are the same as Steps 311, 312, and 313 in FIG. 3, and description thereof is not provided again.

After obtaining the timestamp record value 212 at Step 813, the timestamp record value 212 is stored in the start time 623 in the row of the task management table 541 corresponding to the task 521 to be executed, and the task state 622 is changed to “in execution” (814). After 814, the timestamp at which the task 521 must be terminated, namely a deadline, is calculated from the start time 623 and the time limit 624 (Step 815).

This calculation is, for example, a simple sum of the start time 623 and the time limit 624. The deadline is then set to the interrupt timestamp 536 of the interrupt setting buffer 533, and the interrupt validity flag 535 is set to a value to be “valid” (Step 816). Then the execution of the task 521 is started (Step 817). This makes it possible to record the start time when each task 521 starts its execution.

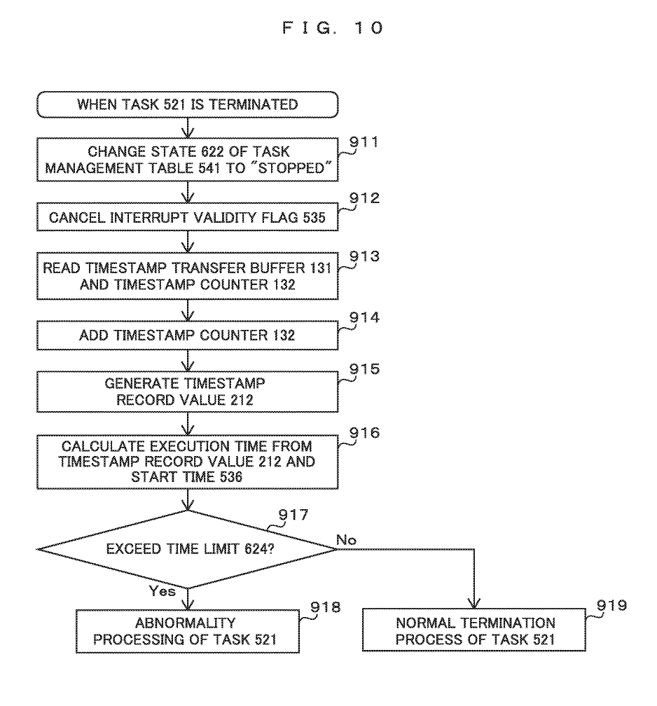

Next, the flow when terminating the execution of the task 521 is described with reference to FIG. 10. First, the task state 622 in the row of the task management table 541 corresponding to the task 521 having terminated the execution is changed to “stopped” (Step 911). The CPU core 110A then sets the interrupt validity flag 535 to a value to be “invalid” (Step 912). This makes it possible to stop the interrupt from the timer device 150 at the deadline timestamp of the task 521 of which execution has been already terminated. Processings at Steps 913, 914, and 915 are the same as Steps 811, 812, and 813, respectively, and therefore the description thereof is not provided again.

The time lapsed from the start to the end of the operation of the task, namely the execution time, is calculated from the timestamp record value 212 generated at Step 915 and the start time 623 (Step 916). This processing is performed by, for example, simple subtraction between two values.

The obtained execution time is then compared with the time limit 624 (Step 917). If the execution time exceeds the time limit 624 (Step 917: Yes), it is determined that the task 521 is executed beyond the specified execution time, which means an abnormal condition. Accordingly, a processing to be performed under such an abnormal condition is performed on the task 521 (Step 918).

This processing can be, for example, preventing the task from being activated again, or reactivating the whole computer system 100. In contrast, if the execution time does not exceed the time limit 624 (Step 917: No), the normal processing of terminating the execution is continued (Step 919).

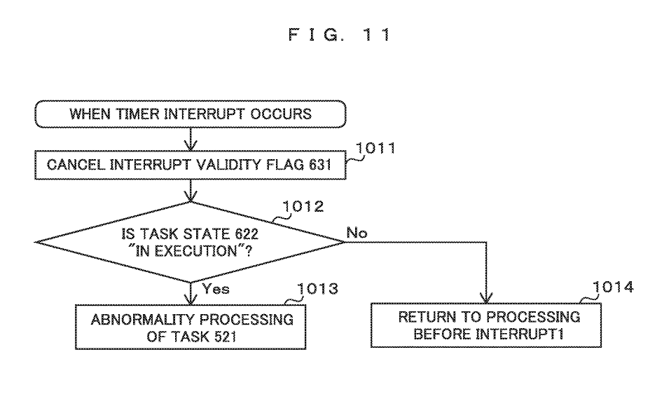

Finally, a case in which an interrupt from the timer device 150 occurs is described with reference to FIG. 11. The CPU core 110A initially sets the interrupt validity flag 535 to a value to be “invalid” (Step 1011). This prevents any further interrupt from occurring.

Next, if the task 521 is operating when the interrupt occurs, the execution state of the task 521 is determined by the task state 622 in the corresponding row of the task management table 541 (Step 1014). If the task state 622 is “in execution” (Step 1014: Yes), Steps 913, 914, and 915 are performed (1013), and if the obtained execution time exceeds the time limit 624 (Step 1012: Yes), processing is performed for the abnormality of the task 521 (Step 1015).

If the task is not executed (Step 1014: No) and the execution time is not exceeded (Step 1012: No), the process returns to the processing before the interrupt (Step 1016).

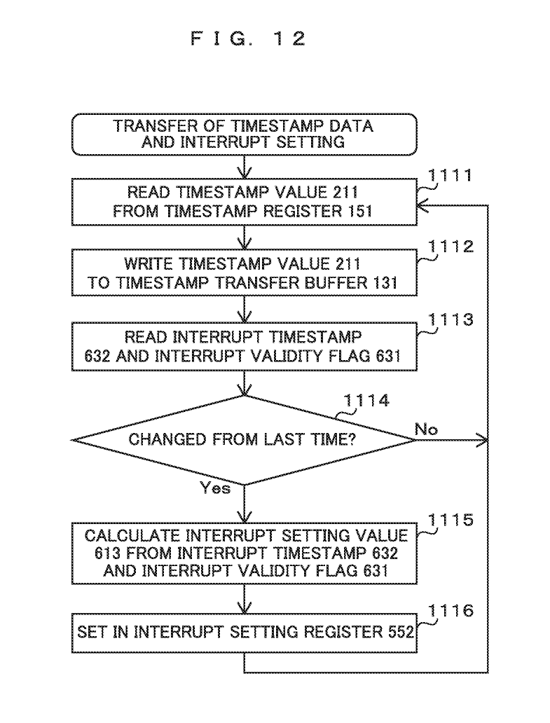

FIG. 12 shows an example of the operation flow of the CPU core 110B when the interrupt is used. Steps 1111 and 1112 are the same as Steps 411 and 412, respectively, and description thereof is not provided again. After Step 1112, the CPU core 110B reads out the values of the interrupt validity flag 535 and the interrupt timestamp 536 in the interrupt setting buffer 533 (Step 1113). Then these values are compared to see if they have changed from the last readings (Step 1114). If they changed (Step 1114: Yes), it means that the CPU core 110A has changed the setting of the timer device 150, and so the transfer to the interrupt setting register 552 is actually performed.

To do so, the interrupt setting value 613 corresponding to the contents of the interrupt validity flag 535 and the interrupt timestamp 536 are calculated first (Step 1115). The calculated interrupt setting value 613 is then set in the interrupt setting register 552 (Step 1116). This is the end of the transfer. After completion of setup in the interrupt setting register 552 or when the setup in the interrupt setting register 552 is not required (Step 1114: No), the CPU core 110B returns to Step 1111. As described with reference to FIG. 4, the processing by the CPU core 110B described above may not always be repeated but may be operated only when any processing with higher priority is not operating.

While two examples have been described above, when values on the same primary storage device 120 are accessed by a plurality of cores, a procedure necessary for the software to retain the consistency may be performed when loading or storing the values on the primary storage device 120 in each example, if any. For example, it may be a special command on the CPU 110 or a method using an exclusive control on the software, such as a typical lock.

While the case of obtaining the timestamp from the timer device is taken as an example in both example, the present invention is not limited to the timestamp information obtained from the timer device but can be applied to any information having a total or local monotonicity as the nature of the value. The timestamp is one example having a nature of monotonically increasing its value.

### REFERENCE SIGNS LIST

100 . . . Computer system,
110 . . . CPU,
131 . . . Timestamp transfer buffer,
132 . . . Timestamp counter,
150 . . . Timer device,
151 . . . Timestamp register,
160 . . . DMA device.

1. A computer system comprising a first processing unit, a second processing unit, a primary storage device, and a timer device, wherein
the timer device stores in the timer device timestamp information and includes a timestamp register accessible from the second processing unit,
the primary storage device includes a timestamp transfer buffer that stores in the primary storage device the timestamp information that the second processing unit read from the timestamp register of the timer device,
the first processing unit reads the timestamp information from the timestamp transfer buffer, and
the second processing unit stores the timestamp information in the timestamp transfer buffer at a different timing from the first processing unit reading the timestamp information.

2. The computer system according to claim 1, wherein
the primary storage device comprises a counter area that stores therein count information, and the first processing unit updates the count information upon reading the timestamp information of the timestamp transfer buffer.

3. The computer system according to claim 2, wherein
the first processing unit refers to the timestamp information in the timestamp transfer buffer and the count information in the counter area, and generates timestamp information used for processing performed by the first processing unit based on the obtained timestamp information and count information.

4. The computer system according to claim 1, wherein
the timer device comprises an interrupt setting register in which the second processing unit stores timer interrupt information, and
the second processing unit sets the timer interrupt register including information about an execution time of a task that the first processing unit wrote in the primary storage device in the interrupt setting information.
